(19) United States
(12) Patent Application Publication
(10) Pub. No.: US 2007/0115259 A1
(43) Pub. Date: May 24, 2007

(54) Receiving structure for receiver of wireless mouse

(75) Inventor: Min-Fang Pai, Hsin-Tien City (TW)

Correspondence Address: TROXELL LAW OFFICE PLLC, SUITE 1404, 5205 LEESBURG PIKE, FALLS CHURCH, VA, 22041, US

(73) Assignee: ADOMAX TECHNOLOGY CO., LTD.

(21) Appl. No.: 11/284,820

(22) Filed: Nov. 23, 2005

(51) Int. Cl. G09G 5/08

(52) U.S. Cl. 345/163

(57) ABSTRACT

A receiving structure for a receiver of a wireless mouse is disclosed. An accommodating slot for receiving a receiver is disposed on rear end of an upper cover of a wireless mouse. And a vertical pin on an arm is arranged on center line of a bottom plate of the accommodating slot. The vertical pin moves elastically and turns back automatically while being forced. An elastic member and a limit switch for power control are disposed in front of the accommodating slot. Two consecutive front and rear stopping plates corresponding to the vertical pin are disposed on bottom of the receiver and two sloped guiding surfaces in opposite directions are arranged on the front and rear stopping plates respectively. When the receiver plugs into the accommodating slot, the sloped guiding surface of the front stopping plate presses the pin to move outwards, away from the central line and then leaves the rear end of the sloped guiding surface and locks into the arc of the front stopping plate. Thus the receiver can't be drawn back and locked inside the accommodating slot. At the same time, the receiver contacts the limit switch so that the power is turned off. Further press the rear surface of the receiver, the rear stopping plate forces the vertical pin to move along the sloped guiding surface of the rear stopping plate, far away from the center line. The vertical pin passes a bar on lateral side of the arc of the front stopping plate and stops over the locking area inside the arc of the front stopping plate. Therefore, the receiver is bounced out of the accommodating slot by elasticity of the elastic member and the receiver leaves the limit switch so that the power is on. The structure is simplified and the receiver is easily plugged in/out.

### BACKGROUND OF THE INVENTION

The present invention relates a receiving structure for a receiver of a wireless mouse, especially to an accommodating slot on the mouse. The accommodating slot with an elastic moveable vertical pin of an arm on a enter line of a bottom plate thereof corresponds to a consecutive front and rear stopping plates on a bottom plate of a receiver. When vertical pin contacts with the front and rear stopping plate, it moves elastically and then turns back automatically. Thus the receiver inserted into the accommodating slot of the mouse is locked automatically. By pressing the receiver inwards, the receiver is bounced out of the accommodating slot. Therefore, the present invention has simple structure with the effect of easily plugging in/out the receiver.

The trend of design of electronic products available now is becoming light, think, and compact and a single product with multiple functions such as Personal Digital Assistant. In order to meet users requirements, the PDA has more and more functions except basic functions such as, name books, translation machines, calculators, notebooks and playing games, it also integrates with wireless transmission, networking, mobile phones, fax machines, digital cameras and handwriting input.

Therefore, the PDA is not only PDA, it also works as palm top computer. Moreover, computers have a plurality of peripherals such as mouse with or without wires, keyboard, card readers or printers. In order to reduce cost and meet users' needs, manufactures simplify the structure of the devices or integrate various devices into one. For example, refer to the PCT Patent Abstract for the International Publication Number WO 00/46659, on Aug. 10, 200, DATA INPUT DEVICE AND COMPUTER SYSTEM, A mouse 11 mounted thereon with an IC card reader/writer 30 for reducing cable connections to the computer to provide the small, light-weight easy-to-carry computer.

Moreover, PCT Patent Abstract for the International Publication Number WO 98/48390 (published on Oct. 29, 1998)—“DEVICE FOR TRANSMITTING AND RECEIVING INFORMATION CONNECTABLE TO AN ELECTRONIC COMPUTER”—A device 10 connectable to a computer 16 to perform both the function of recorder/reader 12 of banking cards 15 and the function of “mouse” or pointing device 11. The device 10 comprises a slot 19 for the insertion of “smart card” 15 and a plurality of buttons 24, 25. Or Taiwanese Utility Patent publication No 499009, published on Aug. 11, 2002, an improved computer mouse features on that a data reader 17 on top of the inner space of the mouse consists of a locking slot 17 with a flat opening. A connecting device for a memory card 2 is disposed inside the locking slot 17 for connection with an input interface 12 and reading data of the memory card 2. In accordance with above description, an opening is disposed on a housing of a mouse and a slot extends from the opening towards inner space of the mouse for connection with other computer peripherals such as memory cards. For example, a groove 19 disclosed inside the Patent WO 98/48390, or a locking slot 17 disclosed in the Taiwanese patent publication No 499009 is considered as prior art of a slot of the computer mouse.

Furthermore, Taiwanese utility patent publication No. 560653, published on Nov. 1, 2003, “wireless input device for receiving receiver” (also US patent Pub. No. US 2005/0073499 A1), Taiwanese utility patent publication No. 555094, published on Sep. 21, 2003,” wireless device for receiving receiver”, and Taiwanese utility patent publication No. 545648, published on Aug. 1, 2003,” wireless input device for receiving receiver” (also US patent Pub. No. US 2003/0179177 A1) are all related to an improved mouse that has a receiver for wireless mouse instead of a slot inside the mouse.

However, as to common mouse, no matter mechanical type (scroll ball) or optical type, the small volume is disposed with basic parts-circuit devices such as circuit board and transmitter, sensor (mechanical or optical type), input devices such as buttons or roller and power supply such as battery holder. Thus the design of a slot for receiving other computer devices such as receiver needs to be with simple structure, durability, and easily plugging in/out for meeting users' requirements. The above utility patent publication No, 560653, No. 555094 and No. 54564, the parts for slots and receivers inside wireless mouse are quite lot and the connections between the parts are also complicated. Thus it is easy to get damage after being used for a long time. Refer to Patent publication No. 560653, the receiver is plugged into the bottom of the mouse by two-stage operation and this made users inconvenient. Therefore, there is a need to improve the design of the accommodation space inside a wireless mouse for receiving the receiver.

### SUMMARY OF THE INVENTION

Therefore it is a primary object of the present invention to provide a receiving structure for a receiver of a wireless mouse that has an accommodating slot for receiving a receiver disposed on rear end of an upper cover thereof. And a vertical pin on an arm is arranged on center line of a bottom plate of the accommodating slot. The vertical pin moves elastically and turns back automatically while being forced. Two consecutive front and rear stopping plates corresponding to the vertical pin are disposed on bottom of the receiver while two sloped guiding surfaces in opposite directions are arranged on the front and rear stopping plates respectively. A bar is arranged on lateral side between the front and rear stopping plates. When the receiver inserts into the accommodating slot, the sloped guiding surface of the front stopping plate presses the pin to move along the sloped guiding surface, away from the central line. When the pin moves to rear end of the sloped guiding surface, it turns back automatically and locks into the arc of the front stopping plate. Thus the receiver is locked inside the accommodating slot. Furthermore, press the rear surface of the receiver towards the accommodating slot, the rear stopping plate forces the vertical pin to move along the other sloped guiding surface, far away from the center line. The vertical pin passes the bar on lateral side between the front and rear stopping plates and stops over the locking area inside the arc of the front stopping plate. Therefore, the receiver leaves the front stopping plate completely and is bounced out of the accommodating slot by elasticity of the elastic member. The structure is simplified and the receiver is easily plugged in/out.

It is another object of the present invention to provide a receiving structure for a receiver of a wireless mouse that has a limit switch on the base of the mouse, corresponding to front side of the accommodation slot. The limit switch is connected with the battery power source inside the wireless mouse so as to control on/off of the power source. When the receiver is inserted and locked inside the accommodation slot of the mouse, the connecting part on front end of the receiver contacts and presses the limit switch so as to turn off the power source of the mouse. Thus the purpose of electricity saving is achieved.

It is a further object of the present invention to provide a receiving structure for a receiver of a wireless mouse that has a lid controlled by an elastic pivotal axis is disposed on an opening of an accommodation slot of the wireless mouse. When the receiver inserts into the slot, the lid is pivoted inwards and opened automatically. While pulling the receiver out of the slot, the lid automatically pivots back and covers the opening of the accommodation slot for dustproof and aesthetic effects.

### BRIEF DESCRIPTION OF THE DRAWINGS

FIG. 1 is a perspective view of a mouse of an embodiment in accordance with the present invention;

FIG. 2 is a mouse and a receiver of an embodiment in accordance with the present invention;

FIG. 3 is an upper cover of the mouse in accordance with the present invention;

FIG. 3A is an enlarged view of part A in FIG. 3;

FIG. 3B is an enlarged view of part B in FIG. 3;

FIG. 4 is a schematic drawing showing the receiver in FIG. 3 locks inside the accommodation slot of the mouse in accordance with the present invention;

FIG. 5A to FIG. 5D are schematic drawings showing movement of vertical pin inside the accommodation slot of mouse in accordance with the present invention;

FIG. 6 is a schematic drawing showing the receiver in FIG. 4 bouncing outwards from the accommodation slot in accordance with the present invention;

FIG. 7 is a schematic drawing showing the upper cover and the base separated with each other in accordance with the present invention.

### DETAILED DESCRIPTION OF THE PREFFERED EMBODIMENT

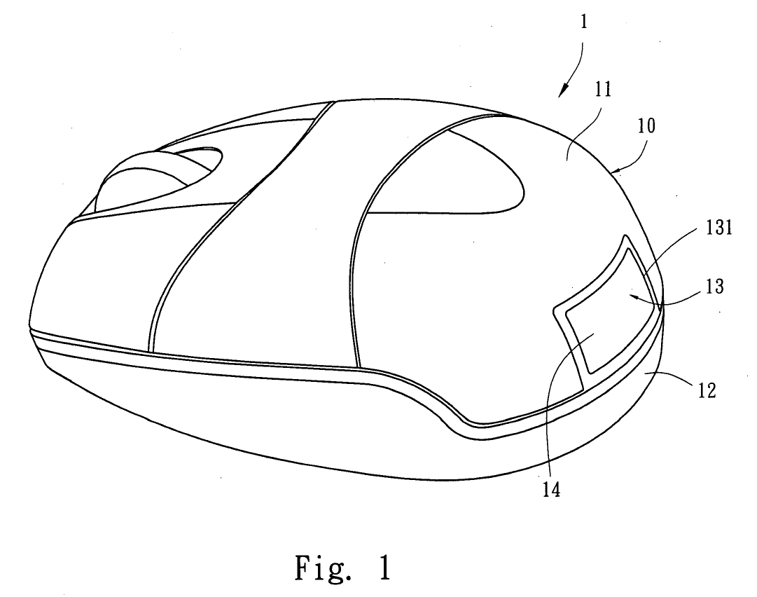

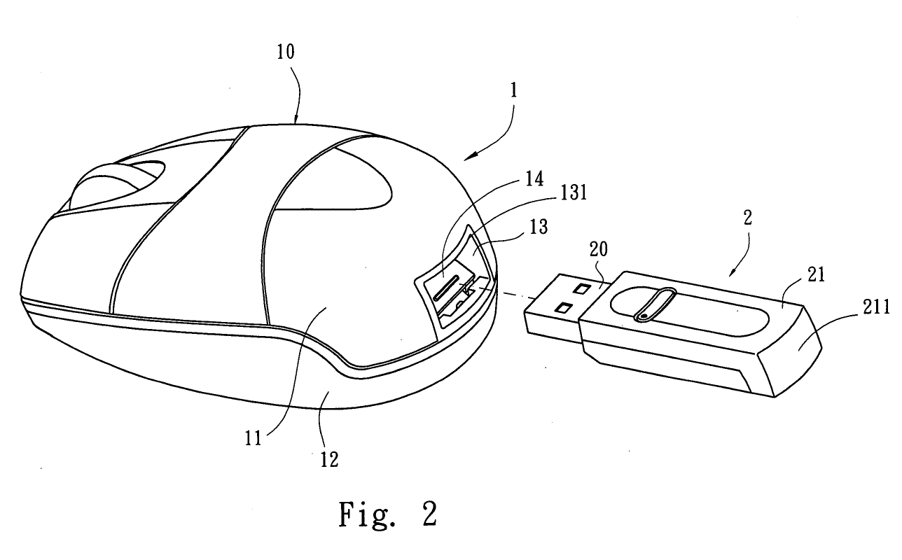

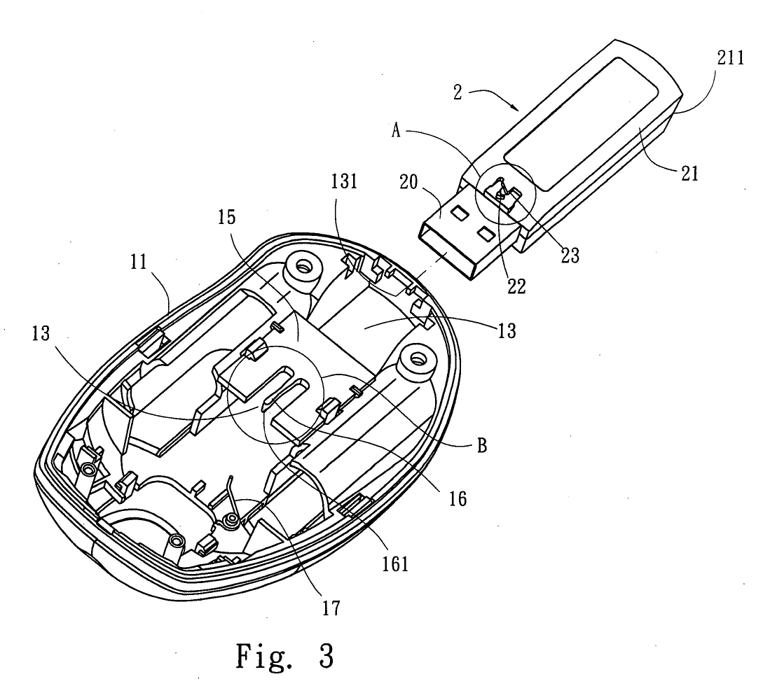

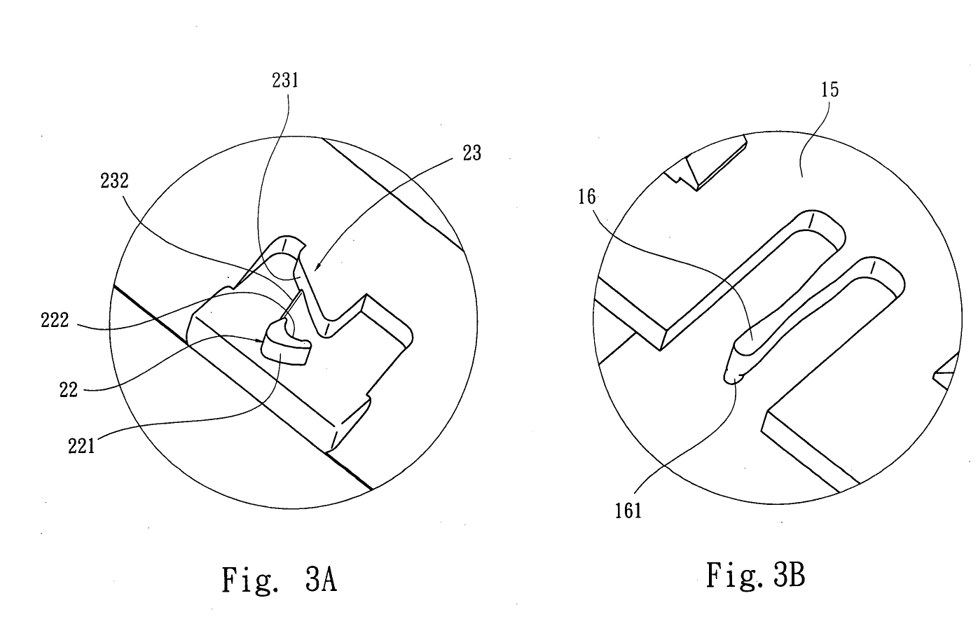

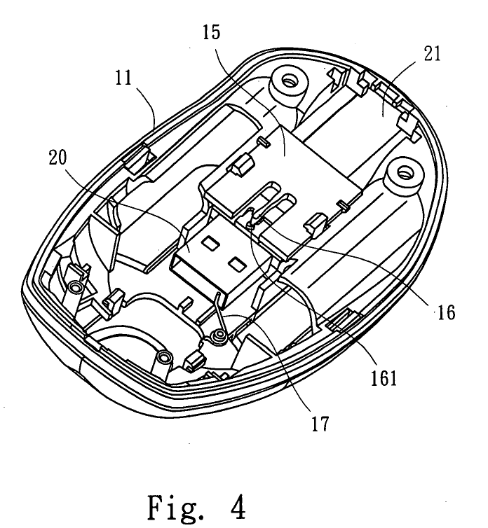

Refer to FIG. 1, FIG. 2, FIG. 3, FIG. 3A & FIG. 3B, a receiving structure for a receiver of a wireless mouse in accordance with the present invention includes a wireless mouse 1 and a receiver 2. In usage, the receiver 2 is inserted into a main frame of computer while the wireless mouse 1 sends input signal into the receiver 2 by the batteries therein so as to achieve the purpose of remote control. The wireless mouse 1 consists of an enclosing 10 having an upper cover 11 and a base 12, circuit devices such as circuit board and transmitter, sensor (mechanical or optical type), input devices such as buttons or roller and power supply such as battery holder for providing the transmitter electricity . . . and so on. The wireless mouse 1 of the present invention can be a mechanical mouse or an optical mouse, the later is preferred.

The present invention features on that:

An accommodating slot 13 with an opening 131 is disposed on rear part of the upper cover 11 of the wireless mouse 1. The accommodating slot 13 is formed by the opening 131 on rear plane of the upper cover 11 extends insides the upper cover 11 horizontally. The width and depth of the accommodating slot 13 depends on the shape of the receiver 2. Moreover, a lid 14 controlled by an elastic pivotal axis is disposed on edge of the opening 131 of the slot 13. When the receiver 2 inserts into the slot 13 through the opening 131, the lid 14 is pivoted inwards as shown in FIG. 2. And a rear surface 211 of a main body 21 of the receiver 2 matches on the surface of the opening 131. While pulling the receiver 2 out of the slot 13 through the opening 131, the lid 14 automatically pivots back and covers the opening 131 for dustproof and aesthetic effects, as shown in FIG. 1.

Refer to FIG. 3 & FIG. 3B, a bottom plate 15 is arranged on the bottom of the slot 13. The bottom plate 15 made from plastic is fixed on the inside the upper cover 11 to define the bottom area of the slot 13 so that the receiver 2 attaches on the bottom plate 15 while inserting into the accommodating slot 13. An arm 16 with certain length extending backwards is arranged on a center line of the bottom plate 15. A vertical pin 161 is installed at the rear end of the arm 16. The vertical pin 161 projects toward the inner space of the accommodating slot 13 vertically and the head part of the vertical pin 161 is preferred a sphere. By the elasticity of the arm 16, the vertical pin 161 moves while being forced and then turns back automatically. Moreover, an elastic member 17 is arranged on front end of the accommodating slot 13. When the receiver 2 inserts into and locks with the accommodating slot 13, a connecting part 20 of the receiver 2 contacts the elastic member 17 and presses it to retract backwards so that the reaction force of the elastic member 17 becomes the return (bounce) force of the receiver 2.

As shown in FIG. 3 & FIG. 3A, the receiver 2 consists of the connecting part 20 and the main body 21. Two consecutive front and rear stopping plates 22, 23 corresponding to the pin 161 are disposed on bottom of the main body 21. Two sloped guiding surfaces 221, 231 in opposite directions are arranged on the front and rear stopping plates 22, 23 respectively. The rear end of the sloped guiding surface 221 of the front stopping plate 22 forms an arc 222, working as a stopping point of the vertical pin 161. Moreover, a bar 232 is arranged on the arc 222, on the same side with the sloped guiding surface 231 of the rear stopping plate 23. The bar 232 extends from the rear end of the sloped guiding surface 231 to the corresponding side of the sloped guiding surface 221 so that the bar 232 forms a party line between the inner area and outer area of the arc 222. The slope of the inner area of the bar 232 is a gentle slope while the slope of the outer area is a steep slope. Thus the vertical pin 161 is easy to move from the gentle slope to the steep slope area, passing through the bar 232 while it is difficult to move back. The procedures of plugging in and pulling out the receiver 2 from the wireless mouse 1 are described as followings:

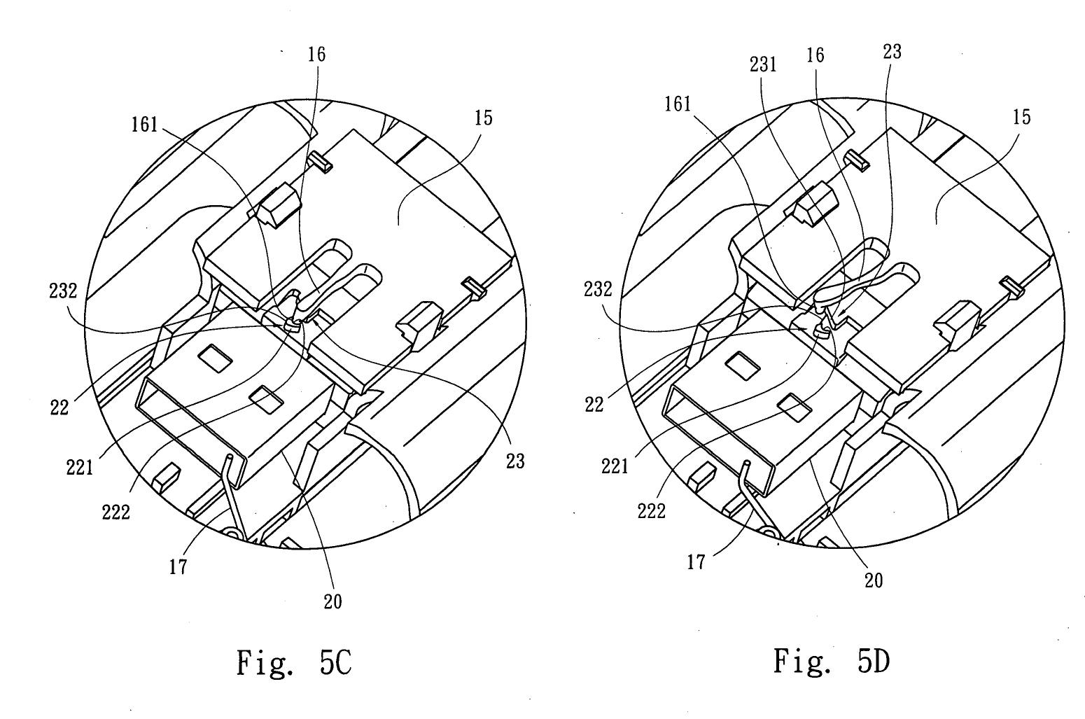

When the receiver 2 is plugged into the accommodating slot 13 of the wireless mouse 1, as shown in FIG. 5A, the connecting part 20 of the receiver 2 contacts and presses the elastic member 17 to move backwards. Now the sloped guiding surface 221 of the front stopping plate 22 also leans against the pin 161 and presses it to move outwards along the sloped guiding surface 221, away from the central line.

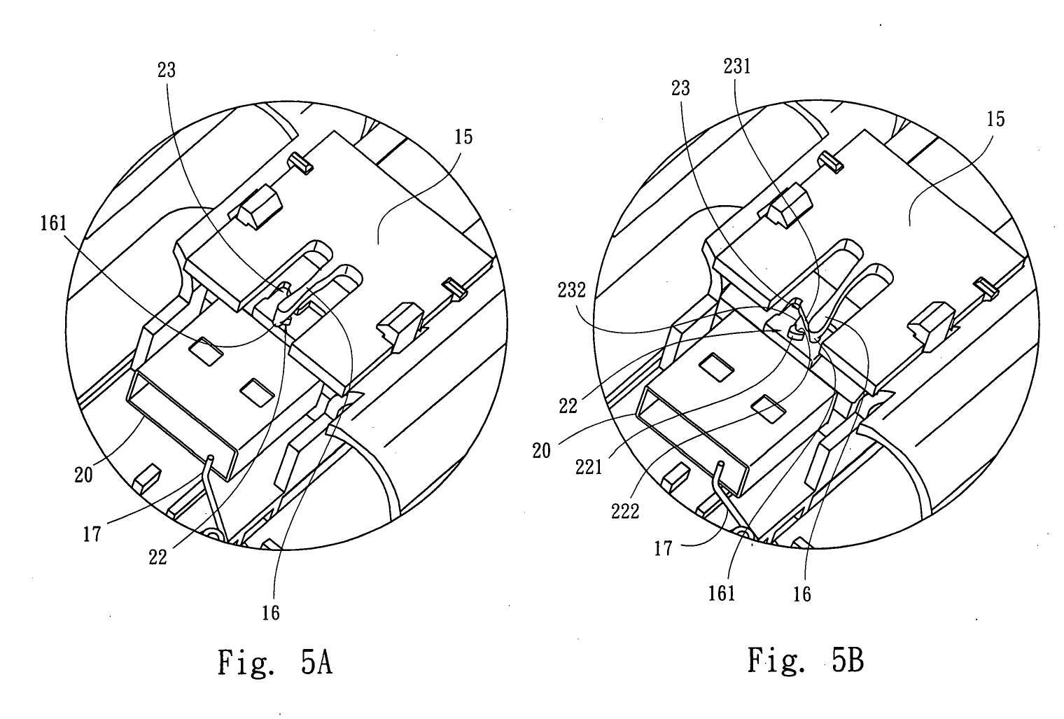

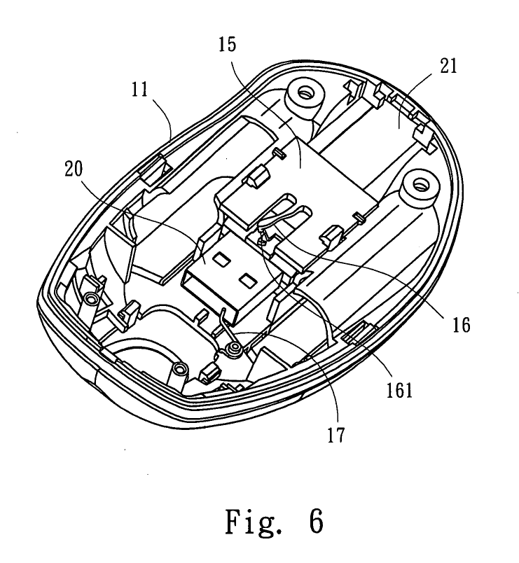

Refer to FIG. 5B, when the receiver 2 continues to move inside the accommodating slot 13, the sloped guiding surface 221 of the front stopping plate 22 pushes the vertical pin 161 to move along the sloped guiding surface 221 elastically, over the rear end of the sloped guiding surface 221. Now the elastic member 17 makes the receiver 2 to have larger return force and the vertical pin 161 automatically turns back towards the central line by means of the elasticity of the arm 16, thus leaving the rear end of the sloped guiding surface 221 and moving into the arc 222 of the front stopping plate 22. Refer to FIG. 5C, by the bounce force that the elastic member 17 acts on the receiver 2, the vertical pine 161 turns into and locks inside the arc 222 of the front stopping plate 22 so as to make the receiver 2 unable to move back, locked inside the accommodating slot 13, as shown in FIG. 4. Refer to FIG. 5D & FIG. 6, when the receiver 2 is pulled out from the accommodating slot 13, press or pull the rear surface 211 of the receiver 2 moving towards the accommodating slot 13 so as to make the receiver 2 moving forward a certain distance. Thus the other sloped guiding surface 231 of the rear stopping plate 23 forces the vertical pin 16 to move far away from the center line, toward the other direction. The vertical pin 16 passes the bar 232 on lateral side and stops on outer side of the bar 232 thus it is over the locking area inside the arc 222 of the front stopping plate 22. Therefore, the receiver 2 is not locked inside the accommodating slot 13 and is bounced out of the accommodating slot 13 by elasticity of the elastic member 17.

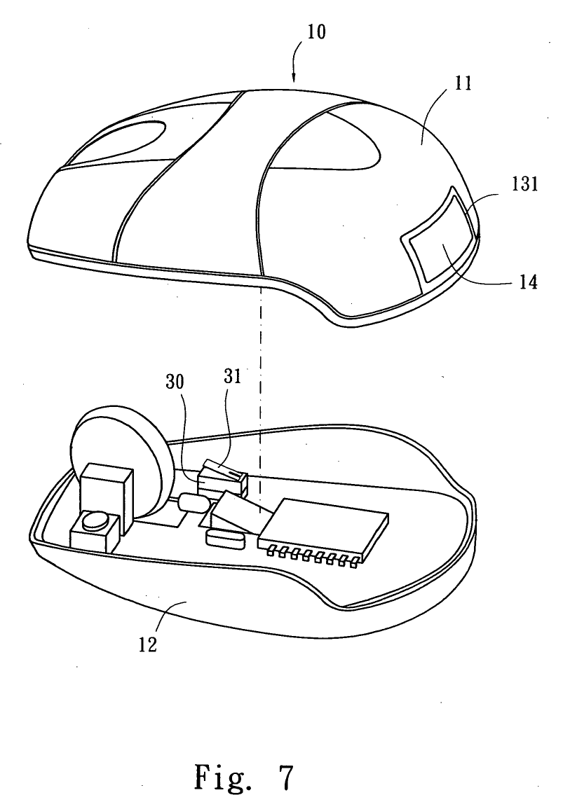

Refer to FIG. 7, a limit switch 30 with an elastic switch 31 is disposed inside the base 12 of the wireless mouse 1, corresponding to the lateral side on front end of the accommodating slot 13 of the upper cover 11. The limit switch 30 is connected with a power source of the mouse 1 for control of the on/off of the power source. When the elastic switch 31 is pressed down, the power source is turned off while the power is on when the elastic switch 31 turns back elastically. Moreover, when the receiver 2 inserts inside the accommodating slot 13 of the upper cover 11, being locked as shown in FIG. 4 & FIG. 5C, the connecting part 20 on front end of the receiver 2 just contacts the elastic switch 31 so that the power is off and the elasticity is saved.

What is claimed is:

1. A receiving structure of a wireless mouse comprising a wireless mouse with an enclosing having an upper cover and a base while a circuit board, sensor, input devices and batteries are disposed inside the enclosing and by power supply from batteries, input signals are transmitted to a receiver that is plugged into a computer main unit; the receiving structure is characterized in that: an opening and an accommodating slot formed by horizontal extension of the opening towards inner side of the upper cover while the width and depth of the accommodating slot depends on the shape of the receiver so that the receiver is accommodated inside the accommodating slot; a plastic bottom plate is arranged on the bottom of the slot so that the receiver attaches on the bottom plate while inserting into the accommodating slot; an arm with certain length extending backwards is arranged on a center line of the bottom plate and a vertical pin projecting vertically toward the inner space of the accommodating slot is installed at the rear end of the arm; by the elasticity of the arm, the vertical pin moves elastically and turns back automatically; an elastic member is arranged on front end of the accommodating slot; when the receiver plugs into the accommodating slot, a connecting part on front end of the receiver contacts and presses the elastic member; the receiver having the connecting part and a main body and two consecutive front and rear stopping plates corresponding to the pin are disposed on bottom of the main body; two sloped guiding surfaces are arranged on the front and rear stopping plates respectively; the rear end of the sloped guiding surface of the front stopping plate forms an arc, winding toward a center line thereof, while a bar is arranged on the arc, on the same side with the sloped guiding surface of the rear stopping plate;
thereby when the receiver plugs into the accommodating slot, the sloped guiding surface of the front stopping plate of the receiver presses the vertical pin to move along the sloped, guiding surface, away from the central line and over rear end of the sloped guiding surface, then the vertical pin automatically turns back towards the central line by means of the elasticity of the arm and the elastic member and locks into the arc of the front stopping plate; when the rear surface of the receiver is further pressed inwards, the sloped guiding surface of the rear stopping plate forces the vertical pin to move along the sloped guiding surface thereof, far away from the center line and then the vertical pin passes a bar and stops over the locking area inside the arc of the front stopping plate; thus the receiver leaves the vertical pin, bounced out of the accommodating slot by elasticity of the elastic member.

2. The structure as claimed in claim 1, wherein a head of the pin is preferred a sphere.

3. The structure as claimed in claim 1, wherein one side of the bar facing the arc is a gentle slope while the other end of the bar is a steep slope.

4. The structure as claimed in claim 1, wherein a lid controlled by an elastic pivotal axis is disposed on edge of the opening of the accommodating slot while pulling the receiver out of the accommodating slot through the opening, the lid automatically pivots back and covers the opening of the accommodating slot.

5. The structure as claimed in claim 1, wherein a limit switch with an elastic switch is disposed inside the base of the wireless mouse; the limit switch is connected with a power source of the mouse for control of the on/off of the power source by the elastic switch; when the receiver is plugged and locked inside the accommodating slot of the upper cover, the connecting part on front end of the receiver contacts the elastic switch so as to turn off the power source.
